(19) United States
(12) Patent Application Publication
(10) Pub. No.: US 2026/0172500 A1
(43) Pub. Date: Jun. 18, 2026

(54) DEVICE, SYSTEM, AND METHOD FOR CONTROLLING A VIRTUAL REALITY DEVICE BASED ON SENSOR DATA VIA A PUBLIC SAFETY ANSWERING POINT DEVICE

(71) Applicant: MOTOROLA SOLUTIONS, INC., Chicago, IL (US)

(72) Inventors: Mariya BONDAREVA, Bolingbrook, IL (US); Kevin KINSEY, Salt Lake City, UT (US); Brian W. PRUSS, Streamwood, IL (US); Matthieu CORNIQUET, Roseland, VA (US)

(21) Appl. No.: 18/985,484

(22) Filed: Dec. 18, 2024

(51) Int. Cl. H04M 1/72427; G06F 3/01; G06T 13/40; H04M 1/72421

(52) U.S. Cl. CPC H04M 1/72427; G06F 3/011; G06T 13/40; H04M 1/72421; H04M 2242/04

(57) ABSTRACT

A computing device receives a call placed by a user of a virtual reality (VR) device, and determines a type of the call. The computing device receives sensor data indicative of a biophysical state of the user, and, based on the type of the call and the sensor data, determines: a particular virtual reality environment and a particular avatar for a call taker of the call. The computing device controls the VR device to provide the call using the particular virtual reality environment and the particular avatar.

### BACKGROUND OF THE INVENTION

Public safety answering points (PSAPs) generally rely on voice calls, which are limited in conveying critical information during high-stress interactions. For example, non-verbal components such as appearance of a call taker and/or a caller may significantly impact communication, compared to words only. Such limitations may cause additional usage of processing resources and/or bandwidth at a PSAP, as such limitations may cause calls to the PSAP to lengthen to assess at least high-stress interactions.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for controlling a virtual reality device based on sensor data via a public safety answering point device, in accordance with some examples.

FIG. 2 is a device diagram showing a device structure of a computing device for controlling a virtual reality device based on sensor data via a public safety answering point device, in accordance with some examples.

FIG. 3 is a flowchart of a method for controlling a virtual reality device based on sensor data via a public safety answering point device, in accordance with some examples.

FIG. 4 depicts the system of FIG. 1 implementing aspects of a method for controlling a virtual reality device based on sensor data via a public safety answering point device, in accordance with some examples.

FIG. 5 depicts a VR device 106 and a display screen 116 of a terminal of the system on a call, and the VR device being initially controlled to provide a particular virtual reality environment and particular avatar based on sensor data, in accordance with some examples.

FIG. 6 depicts a VR device 106 and a display screen 116 of a terminal of the system on the call, and the VR device being later controlled to provide a particular virtual reality environment and particular avatar based on sensor data, in accordance with some examples.

FIG. 7 depicts a VR device 106 and a display screen 116 of a terminal of the system on the call, and a VR device of a first responder being patched into the call and an avatar of the first responder added to the particular virtual reality environment, in accordance with some examples.

FIG. 8 depicts the system of FIG. 1 patching the VR device of the first responder into the call, in accordance with some examples.

FIG. 9 depicts different stages of a call, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

At public safety answering points, call-taking resources may be overwhelmed such that calls received at public safety answering points may not be answered immediately due to ongoing voice calls with operators at terminals. Such ongoing voice calls may lengthen unnecessarily as such voice calls may be limited in conveying critical information during high-stress interactions, which may cause additional usage of processing resources and/or bandwidth at the PSAP. While virtual reality devices may address some of these limitations, virtual reality devices are still generally limited to providing specific virtual reality environments and/or avatars that may be fixed.

Thus, there exists a need for an improved technical method, device, and system for controlling a virtual reality device based on sensor data via a public safety answering point device.

An aspect of the present specification provides a method comprising: receiving, by a public safety answering point (PSAP) device, a call placed by a user of a virtual reality (VR) device; determining, by the PSAP device, a type of the call; receiving, by the PSAP device, sensor data indicative of a biophysical state of the user; based on the type of the call and the sensor data, determining, by the PSAP device: a particular virtual reality environment and a particular avatar for a call taker of the call; and controlling, by the PSAP device, the VR device to provide the call using the particular virtual reality environment and the particular avatar

An aspect of the present specification provides a computing device (e.g., a PSAP device) comprising: a controller; and a computer-readable storage medium having stored thereon program instructions that, when executed by the controller, causes the controller to perform a set of operations comprising: receiving a call placed by a user of a virtual reality (VR) device; determining a type of the call; receiving sensor data indicative of a biophysical state of the user; based on the type of the call and the sensor data, determining: a particular virtual reality environment and a particular avatar for a call taker of the call; and controlling the VR device to provide the call using the particular virtual reality environment and the particular avatar.

Each of the above-mentioned aspects will be discussed in more detail below, starting with example system and device architectures of the system, in which the embodiments may be practiced, followed by an illustration of processing blocks for achieving an improved technical method, device, and system for controlling a virtual reality device based on sensor data via a public safety answering point device.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As used herein, the term “engine” refers to hardware (e.g., a processor, such as a central processing unit (CPU), graphics processing unit (GPU), a tensor processing unit (TPU), or similar parallel processing units optimized for handling large-scale data and complex machine learning models, an integrated circuit or other circuitry) or a combination of hardware and software (e.g., programming such as machine- or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), a PAL (programmable array logic), a PLA (programmable logic array), a PLD (programmable logic device), etc.

Further advantages and features consistent with this disclosure will be set forth in the following detailed description, with reference to the drawings.

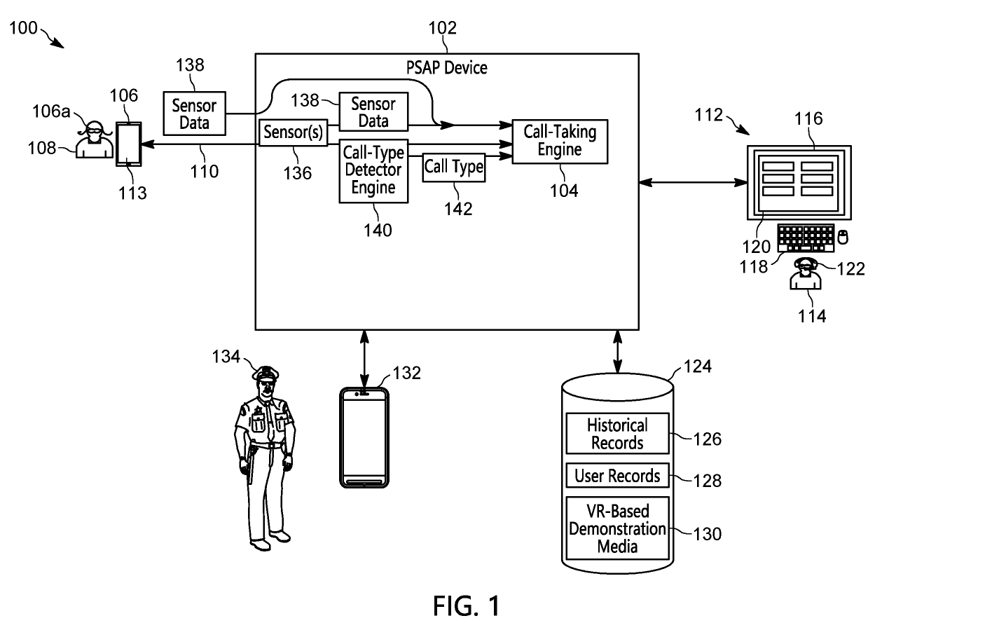

Attention is directed to FIG. 1, which depicts an example system 100 for controlling a virtual reality device based on sensor data via a public safety answering point device. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

The system 100 comprises a public safety answering point (PSAP) device 102, which may be a component of a PSAP. As depicted, the PSAP device 102 is implementing a call-taking engine 104, that may answer calls to the PSAP device 102 and/or assist with calls to the PSAP device 102. Put another way, the PSAP device 102 may be configured as a device, and/or a proxy device, for answering calls from communication devices and/or virtual reality (VR) devices, such as a depicted VR device 106 operated by a user 108.

For example, the user 108 may operate the VR device 106 to place a call 110 to the PSAP device 102 using an emergency number such as “911” to report an incident, a mental health number such as “988” to talk about a mental health issue, and the like. The PSAP device may initially answer the call 110 from the VR device 106 using the call-taking engine 104 and later transfer to the call 110 to a terminal 112. However, the call-taking engine 104 may continue to participate in the call 110, for example to control the VR device 106 to provide a particular virtual reality environment and/or a particular avatar (e.g., a particular virtual reality avatar) as described herein, which may occur after the call 110 is transferred to the terminal 112, or both before and after the call 110 is transferred to the terminal 112. Indeed, after the call 110 is transferred to the terminal 112, the call 110 may be transferred back to the call-taking engine 104, which may conclude the call 110 (and which may or may not continue with providing a particular virtual reality environment and/or a particular avatar as described herein).

The PSAP device 102 may comprise any suitable combination of one or more servers, one or more cloud computing devices, and the like.

The VR device 106 may comprise any suitable communication device and/or combination of communication devices, configured to provide virtual reality environments and avatars, as described herein. While as depicted the VR device 106 comprises a mobile phone and/or cell phone, and the like, the VR device 106 may comprise any suitable combination of VR equipment including, but not limited to, mobile phones, VR headsets, personal computers, laptops, and the like. In the example of the VR device 106 comprising a mobile phone, the VR device 106 may provide virtual reality environments and avatars in two dimensions at a display screen 113 thereof, whereas in the example of the VR device 106 comprising a headset, as depicted, a headset 106a, the VR device 106 may provide virtual reality environments and avatars in three dimensions (e.g., via a pair of display screens, not depicted, but that are understood to be components of such headsets).

Furthermore, in the example of the VR device 106 comprising a mobile phone, the VR device 106 may be used to make the call 110 to the PSAP device 102 using a call-placing application, and may later rely on a virtual reality application to provide virtual reality environments and virtual reality avatars.

Furthermore, in the example of the VR device 106 comprising a combination of a mobile phone and the headset 106a, the mobile phone may be used to make the call 110 to the PSAP device 102 using a call-placing application, for example outside of a virtual reality environment, and the call 110 may later be transferred to the headset 106a to provide virtual reality environments and avatars.

Hereafter, for simplicity, use of the term VR device 106 is understood to include any suitable combination of the depicted mobile phone and the headset 106a. While not depicted it is understood that the VR device(s) 106 further comprise any suitable combination of input and output devices that may assist with providing virtual reality environments and avatars and/or interacting with virtual reality environments and avatars, which may include, but are not limited to, microphones, speakers, keyboards, pointing devices, and the like.

The terminal 112 may be operated by a call taker 114, and may comprise a PSAP call answering terminal, and the like. The terminal 112 may comprise any suitable combination of input and output devices that enable the call taker 114 to answer calls, such as the call 110, and to communicate using virtual reality, for example with the VR device 106. As depicted, the terminal 112 comprises a display screen 116 and an input device 118 (e.g., as depicted, keyboard, as depicted, a pointing device and/or any other suitable input device). However, the terminal 112, the display screen 116 and the input device 118 may be provided in any suitable format, such as a laptop, a personal computer, and the like (e.g., when the call taker 114 is working from home and/or “off-premises” from a PSAP 104-1). In general, the display screen 116 and the input device 118 may be used to interact with the terminal 112, for example via an interface 120 (which may include, but is not limited to, a VR interface) provided at the display screen 116, and the like, which may include, but is not limited to, a virtual reality interface that provides a virtual reality environment at the display screen 116. The terminal 112 further comprises a communication device, for example as represented in FIG. 1 by a headset 122 worn by the call taker 114. In some examples, the headset 122 may comprise a virtual reality headset. Hence, like the VR device 106, the terminal 112 comprises any suitable combination of VR equipment, including, but not limited to the, the combination of the display screen 116 and the input device 118, and the headset 122.

As depicted, the system 100 further comprises a memory 124 (e.g., which, as depicted, may be provided in the form of a database) storing historical records 126 of previous calls, and user records 128 storing records of users who may have previously called into the PSAP device 102. As depicted, the memory 124 further stores VR-based demonstration media 130.

In some examples the records 126, 128 may be combined. Furthermore, while the memory 124 is depicted as external to the PSAP device 102, with the PSAP device 102 communicatively coupled thereto, the memory 124 may be at least partially internal to the PSAP device 102, and/or one or more of the records 126, 128, and the VR-based demonstration media 130 may be at least partially stored at a memory internal to the PSAP device 102.

The historical records 126 may comprise records of calls from users and may include, but is not limited to, indications of previous virtual reality environments and/or avatars used in such calls, as well incidents associated with such calls, user demographic information associated with such calls (e.g., such as age, gender, and the like of users making the calls) and/or demographics of call takers on such calls. The historical records 126 may furthermore include outcomes from such calls, that may include, but are not limited to, lengths of the calls, certain types of sensor data received over the length of such calls, resolutions (or not) of incidents associated with the calls, which may be provided in the form of incident records associated with the calls.

The user records 128 may include user specific records that store the aforementioned demographic information of users, records of specific calls made by the users, phone number and/or addresses of the users, as well as whether access to any sensors at a home of a user has been authorized. For example, a particular user record 128 may be associated with the user 108, and may store their phone number, home address, demographic information, an indication of whether access to any sensors at a home of the user 108 has been authorized (e.g., and their network addresses), as well as records of any previous calls made by the user 108, indications of previous virtual reality environments and/or avatars used in such calls as well as outcomes thereof and/or associated incident records, and certain types of sensor data received over the length of such calls. It should now be apparent that the historical records 126 may store subsets and/or portions of the user records 128, and hence the records 126, 128 may be at least partially combined.

The VR-based demonstration media 130 generally store instructions and/or programming instructions for controlling a VR device (e.g., including, but not limited to, the VR device 106) to provide VR-based demonstrations of different procedures that may be associated with different incidents and/or different mental health states. For example, for medical incidents, the VR-based demonstration media 130 may include instructions and/or programming instructions for controlling a VR device to demonstrate how to perform cardiopulmonary resuscitation (CPR), amongst other possibilities. For home burglary incidents, the VR-based demonstration media 130 may include instructions and/or programming instructions for controlling a VR device to demonstrate how to check if a home security system is functioning. In instances where the user 108 is depressed, the VR-based demonstration media 130 may include instructions and/or programming instructions for controlling a VR device to provide some techniques for dealing with depression.

However the VR-based demonstration media 130 may generally store instructions and/or programming instructions for controlling a VR device to provide any suitable VR-based demonstrations.

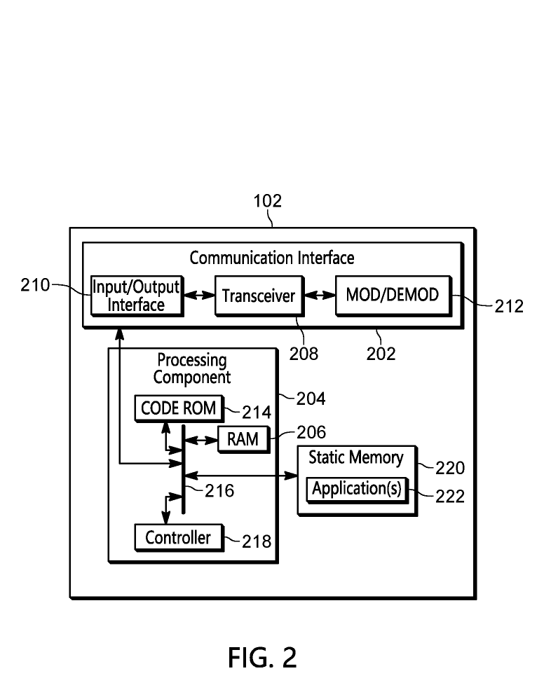

As depicted, the system 100 further comprises a VR device 132 communicatively coupled to the PSAP device 102, that may be operated by, and/or associated with, a first responder 134. The VR device 132 may be similar to the VR device 106, but adapted for first responder functionality, such as including specific types of transceivers used by first responder devices, described in more detail herein with respect to FIG. 2. While as depicted the first responder 134 comprises a police officer, the first responder 134 may comprise any suitable first responder that may include, but is not limited to, the depicted police officer, a firefighter, an emergency medical technician (EMT), and the like. As will be described herein, the PSAP device 102 may be configured to patch the VR device 132 associated with the first responder 134 into a call, such as the call 110. While only one VR device 132 associated with a first responder is depicted, the system 100 may comprise any suitable number of VR devices 132 associated with different types of first responders, that may be patched into calls.

Returning now to the PSAP device 102 and the call-taking engine 104, the PSAP device 102 may further comprise one or more sensors 136 that may measure data from the call 110, for example voice data and/or image data, and generate respective sensor data 138 that may be provided to the call-taking engine 104. The call-taking engine 104 may be used the sensor data 138 to control the VR device 106 to provide the call 110 using a particular virtual reality environment and a particular avatar. In general, the sensor data 138 is understood to be indicative of a biophysical state of the user 108.

The one or more sensors 136 may comprise a spectrum analyzer configured to analyze voice data of the user 108 as received on the call 110. For example, such a spectrum analyzer may determine frequencies of voice data of the user 108 on the call 110, and/or a frequency spectrum the voice data of the user 108 on the call 110, and the like. In these examples, the sensor data 138 may comprise such frequencies and/or frequency spectrum. In particular, such frequencies and/or frequency spectrum may be used to determine a particular virtual reality environment and a particular avatar for use in the call 110.

The one or more sensors 136 may comprise a video analyzer configured to analyze image data of the user 108 as received on the call 110. For example, such a video analyzer may determine arrangements of pixels of image data representing the user 108 on the call 110, and the like. In these examples, the sensor data 138 may comprise such arrangements of pixels of image data. In particular, such arrangements of pixels of image data may be used to determine a particular virtual reality environment and a particular avatar for use in the call 110.

However, in other examples, sensor data 138 may be received, in association with the call 110, and may be received from one or more of the VR device 106 (that may include but is not limited, a communication device initially used to make the call 110, such as mobile phone used to initially make the call 110, and/or a headset), and a location of the user 108, amongst other possibilities.

For example, the VR device 106 may include sensors, such as a spectrum analyzer that may measure the aforementioned frequencies and/or a frequency spectrum, and/or a video analyzer that may measure the aforementioned arrangements of pixels, and the like, and provide such on the call 110 as the sensor data 138. However, the VR device 106 may include other types of sensors, that may include, but is not limited to, one or more of a temperature sensor, an eye-tracking sensor, a heart rate sensor, a galvanic skin response (GSR) sensor, and the like. However, any suitable type of sensor that may measure and/or sense the sensor data 138 that may comprise biometric data that may be used to determine a particular virtual reality environment and a particular avatar for use in the call 110.

A type of sensor at the VR device 106 may, however, depend on a type of the VR device 106. For example, a headset may include one or more of a spectrum analyzer, a video analyzer, a temperature sensor, an eye-tracking sensor, a heart rate sensor, a galvanic skin response (GSR) sensor, and the like, but a mobile phone may include only a spectrum analyzer and/or a video analyzer.

However, the sensor data 138 may be received from any suitable one or more sensors that may be at a location of the user 108, such as a home of the user 108. Such sensors may include, but are not limited to, cameras and/or microphones at the location of the user 108, HVAC (heating, ventilation, and air conditioning) sensors (e.g., that may measure temperature and/or humidity), presence sensors, and the like. Such sensor data 138 may comprise environmental data that may be used to determine a particular virtual reality environment and a particular avatar for use in the call 110. Such sensors that detect environmental data may be part of a smart-home network, and the user 108 may have previously authorized access to such sensors and/or the smart-home network by the PSAP device 102, as may be indicated in the user records 128. Furthermore, in the PSAP device 102 may access the sensors that detect environmental data may be part of a smart-home network using any suitable authentication process, such as a public-key infrastructure process (e.g., to authenticate the PSAP device 102 to the smart-home network), to ensure that such sensors are accessed in a secure and/or authenticated manner.

In general, the sensor data 138 received in association with a location of the user 108 is understood to be indicative of a biophysical state of the user 108.

For example, images (including video) and/or audio data generated by cameras and/or microphones at the location of the user 108 may be analyzed in a manner similar to as described with respect to the sensors 136 and the sensor data 138 from such cameras and/or microphones may include similar information as provided with the sensor data 138 from the sensors 136 (e.g., such cameras and/or microphones may comprise one or more of a spectrum analyzer and a video analyzer as described herein). Alternatively, or in addition, while not depicted, when the sensor data 138 from such cameras and/or microphones includes unanalyzed audio and/or images, the sensor data 138 may be provided to the sensors 136 and analyzed accordingly.

Furthermore, HVAC sensor data that indicate temperature and/or humidity at a location of the user 108 may indicate a temperature and/or humidity felt by the user 108.

Presence data from presence sensors may indicate presence of the user 108 and whether or not the user 108 is alone at the location, which may indicate a stress level of the user 108, which may depend who is with the user 108.

As depicted the PSAP device 102 may further comprise a call-type detector engine 140 that may analyze data received on the call 110 for example, to determine a type 142 of the call 110 (also referred to herein as the call type 142) based, for example, on words spoken by the user 108 on the call 110. The call-type detector engine 140 may comprise any suitable combination of hardware and software that may analyze data received on the call 110, and in particular audio data, for example, to determine a type 142 of the call 110. The call-type detector engine 140 may comprise a voice to text converter, for example, which may convert voice data of audio of the call 110 to text and search for particular words in the text.

For example, when words on the call 110 include “There’s been a burglary”, in this example, a call type 142 may comprise a “Burglary” or any other suitable indicator of a burglary. Hence, call types 142 may include, but are not limited to, calls that are associated with incident types; as such, a call type 142 may include, but is not limited to, an incident type, though any suitable types of calls are within the scope of the present specification.

For example, when the call 110 is a mental health call, and the user 108 on the call 110 may say “I am depressed”, the call type 142 may comprise “Depressed” or any other suitable indicator of a user being depressed.

When no specific call type may be determined, the call type 142 may comprise “Unknown” and the like.

The PSAP device 102 may further receive the sensor data 138 indicative of a biophysical state of the user 108, and based on the call type 142 and the sensor data138 determine: a particular virtual reality environment and a particular avatar for a call taker of the call 110, which may initially comprise a virtual call taker and may otherwise comprise the call taker 114 operating the terminal 112. For example, the call-taking engine 104 may comprise one or more machine learning algorithms that have been trained to receive, as input, a call type and associated sensor data and output a particular virtual reality environment and a particular avatar. For example, the historical records 126 and/or the user records 128 may be used to train such one or more machine learning algorithms.

The PSAP device 102 may control the VR device 106 to provide the call 110 using the particular virtual reality environment and the particular avatar. The particular virtual reality environment and the particular avatar may be provided on the call by the call-taking engine 104.

In general, the particular virtual reality environment and the particular avatar may be determined to minimize a length of the call 110, and/or to maximize positive outcomes for the call 110. Such positive outcomes may include, but is not limited to, controlling the sensor data 138 to values that represent a certain biophysical state of the user 108. For example, initially the sensor data 138 may indicate that the user 108 is stressed and/or upset, which may be indicated by given frequencies in their voice data, given arrangements of pixels in their image data, their temperature, their heart rate, their galvanic skin response, and the like. For example, given frequencies in their voice data and/or given arrangements of pixels in their image data may indicate the user 108 is stressed, and the like. A positive outcome to the call 110 may be controlling the sensor data 138 to values that indicate that the user 108 is less stressed and/or more relaxed, which may be indicated by other given frequencies in their voice data, other given arrangements of pixels in their image data, their temperature and/or heart rate and/or their galvanic skin response being lowered, and the like. For example, given frequencies in their voice data and/or given arrangements of pixels in their image data may indicate the user 108 is less stressed, and the like, than initially indicated by previously received given frequencies in and/or given arrangements of pixels. While some of the sensor data 138 may comprise environment data, such environmental data may not be used in such determinations, but such environmental data may be used to initially choose the particular virtual reality environment and the particular avatar.

For example, the particular virtual reality environment may be chosen to have a particular color scheme, represent particular furniture, represent a particular location, represent a particular type of location, and the like.

Similarly, the particular avatar may be chosen to represent a certain person and/or a person of a particular set of demographics, that may include, but is not limited to, a particular age range, a particular gender, a particular culture, a particular hair type and/or color, a particular eye color, and the like. Similarly, the particular avatar may be chosen to be wearing certain types of clothing, and the like.

Indeed, over the length of the call 110, the sensor data 138 may continue to be received and the particular virtual reality environment and/or the particular avatar may be changed accordingly in a feedback loop to attempt to achieve given frequencies in voice data of the user 108, given arrangements of pixels in image data of the user 108, reducing temperature of the user 108, reducing heart rate of the user 108, reducing galvanic skin response of the user 108, and the like. Put another way, over the length of the call 110, the sensor data 138 may continue to be received and the particular virtual reality environment and/or the particular avatar may be changed accordingly in a feedback loop to attempt to reduce stress in the user 108, which may generally result in shortening the call 110 to free up processing resources and/or bandwidth at the PSAP device 102.

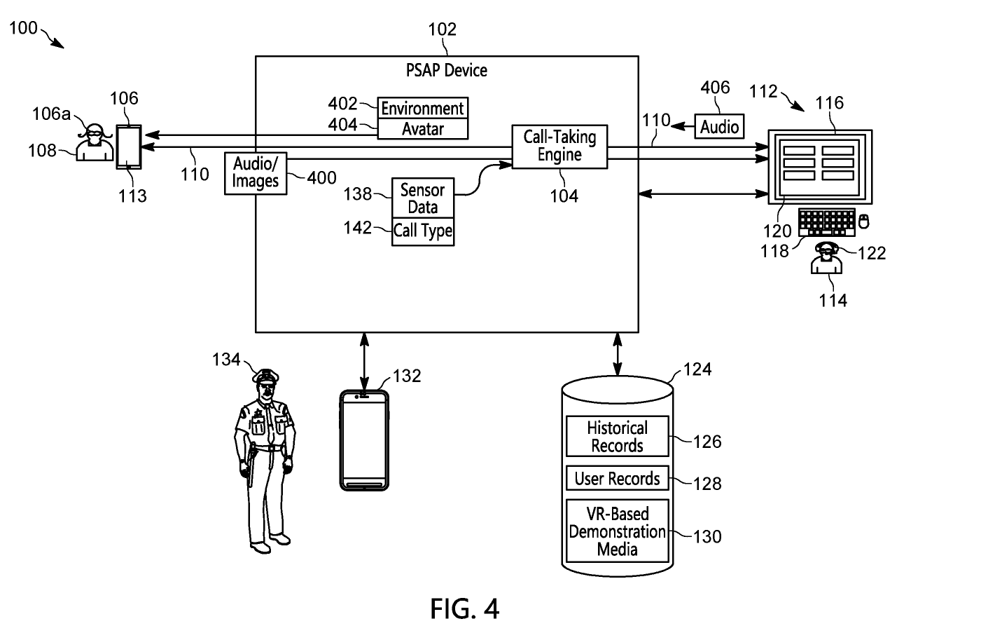

Specific examples of particular virtual reality environments and particular avatars are described below with respect to FIGS. 4 to 8.

Attention is next directed to FIG. 2, which depicts a schematic block diagram of an example of the PSAP device 102. While the PSAP device 102 is depicted in FIG. 2 as a single component, functionality of the PSAP device 102 may be distributed among a plurality of components and the like including, but not limited to, any suitable combination of one or more servers, one or more cloud computing devices, and the like.

As depicted, the PSAP device 102 comprises: a communication interface 202, a processing unit 204, a Random-Access Memory (RAM) 206, one or more wireless transceivers 208 (e.g., which may be optional), one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the PSAP device 102 may have any suitable structure and/or configuration. Furthermore, a portion of the memory 220 may comprise the memory 124.

While not depicted, the PSAP device 102 may include, and/or be in communication with, one or more of an input device and a display screen (and/or any other suitable notification device) and the like, such as the input device 118 and/or the display screen 116 of the terminal 112, and the like.

As shown in FIG. 2, the PSAP device 102 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

It is understood that the DMR transceivers, P25 transceivers, and TETRA transceivers may be particular to first responder devices, and hence such transceivers may be used to communicate with the VR device 132.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may be implemented as a plurality of processors, one or more multi-core processors, or specialized hardware accelerators such as Graphics Processing Units (GPUs), Tensor Processing Units (TPUs), or similar parallel processing units optimized for handling large-scale data and complex machine learning models. The controller 218 may be configured to execute different programming instructions, including those optimized for artificial intelligence and/or machine learning tasks as described herein. Alternatively, or in addition, the controller 218 may include one or more ASIC (application-specific integrated circuits) and one or more FPGA (field-programmable gate arrays), and/or another electronic device.

In some examples, the controller 218 and/or the PSAP device 102 is not a generic controller and/or a generic device, but a device specifically configured to implement functionality for controlling a virtual reality device based on sensor data via a public safety answering point device. For example, in some examples, the PSAP device 102 and/or the controller 218 specifically comprises a computer executable engine configured to implement functionality for controlling a virtual reality device based on sensor data via a public safety answering point device.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the PSAP device 102 as described herein are maintained, persistently, at the memory 220 and used by the controller 218, which makes appropriate utilization of volatile storage during the execution of such programming instructions.

The application 222 may further comprise one or more sets of programming instructions that, when executed by the controller 218, enables the controller 218 to implement the call-taking engine 104. Indeed, as the call-taking engine 104 is described herein as providing virtual avatars on calls, and such virtual avatars may provide audio on the calls, the application 222 and/or the call-taking engine 104 may include a text-to-voice-module, and text corresponding to questions that may be asked on calls. Similarly, the application 222 and/or the call-taking engine 104 may include a voice-to-text-module to convert voice data on a call to text, for example to provide a transcript of a call.

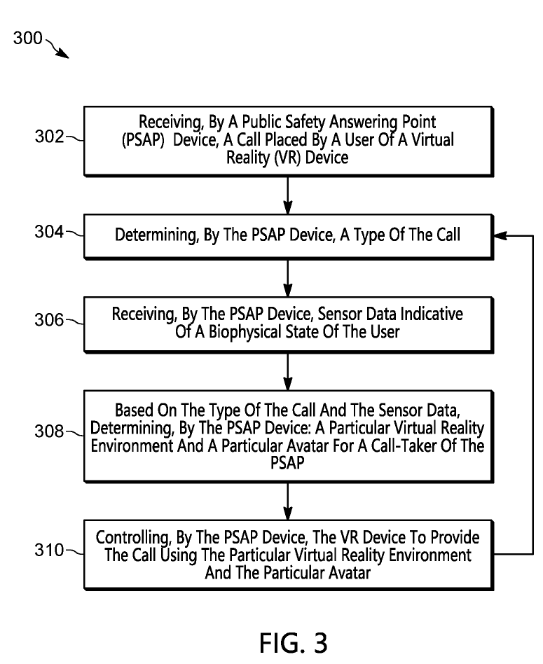

Regardless, it is understood that the memory 220 stores instructions corresponding to the at least one application 222 that, when executed by the controller 218, enables the controller 218 to implement functionality for controlling a virtual reality device based on sensor data via a public safety answering point device, including, but not limited to, the blocks of the method set forth in FIG. 3.

While not depicted, the application 222 may generally include modules for implementing the engines 104, 140 and/or for implementing the aforementioned spectrum analyzer and/or video analyzer, and the like.

The application 222 may include programmatic algorithms, and the like, to implement functionality as described herein.

Alternatively, and/or in addition, application 222 may include one or more machine learning algorithms that may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

When one or more machine learning algorithm are used to implement such functionality, the one or more machine learning algorithm may be trained to determine a particular virtual reality environment and a particular avatar for a call taker of a call, based on a type of the call and sensor data using, for example, appropriate (positive and/or negative) training data that may be manually generated, or generated by a training data generation computing device.

For example, positive training data for based on the type of the call and the sensor data may include positive training input comprising different combinations of call types and sensor data, and positive training output may comprise associated particular virtual reality environments and particular avatars that lead to predetermined positive outcomes for calls, as described herein, such as calls shortening, and/or biophysical states of users indicating decreasing stress over a call. Such particular virtual reality environments and particular avatars may be manually determined, or may be determined using a programmatic algorithm, and the like.

Similarly, negative training data for based on the type of the call and the sensor data may include negative training input comprising different combinations of call types and sensor data, and negative training output may comprise associated particular virtual reality environments and particular avatars that lead to predetermined negative outcomes for calls, such as calls lengthening, and/or biophysical states of users indicating increasing stress over a call. Such particular virtual reality environments and particular avatars may be manually determined, or may be determined using a programmatic algorithm, and the like.

While details of the VR devices 106, 132 and the terminal 112 are not depicted, the VR devices 106, 132 and the terminal 112 may have components similar to the PSAP device 102 adapted, however, for the functionality thereof.

Attention is now directed to FIG. 3, which depicts a flowchart representative of a method 300 for controlling a virtual reality device based on sensor data via a public safety answering point device. The operations of the method 300 of FIG. 3 correspond to machine readable instructions that are executed by the PSAP device 102, and specifically the controller 218 of the PSAP device 102. In the illustrated example, the instructions represented by the blocks of FIG. 3 are stored at the memory 220 for example, as the application 222. The method 300 of FIG. 3 is one way that the controller 218 and/or the PSAP device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

At a block 302, the controller 218, and/or the PSAP device 102, receives (e.g., via the communication interface 202) a call 110 placed by a user 108 of a virtual reality (VR) device 106.

At a block 304, the controller 218, and/or the PSAP device 102, determines a type 142 of the call 110.

At a block 306, the controller 218, and/or the PSAP device 102, receives sensor data 138 indicative of a biophysical state of the user 108.

The sensor data 138 may be received from sensors of one or more of: the VR device 106; a communication device (e.g., the mobile device depicted in FIG. 1) initially used to make the call 110; a location of the user 108; a spectrum analyzer analyzing voice data of the user 108 (e.g., the one or more sensors 136); and a video analyzer analyzing image data of the user 108 (e.g., the one or more sensors 136).

At a block 308, the controller 218, and/or the PSAP device 102, based on the type 142 of the call 110 and the sensor data 138, determines: a particular virtual reality environment and a particular avatar for a call taker 114 of the call 110.

In some examples, one or more of the particular virtual reality environment and the particular avatar may be determined, by the controller 218, and/or the PSAP device 102, further based on one or more of: historical calls from one or more of the user 108 and other callers; and information associated with the user 108 available to the PSAP device 102. For example, one or more of particular virtual reality environment and the particular avatar may be determined, by the controller 218, and/or the PSAP device 102, further based on one or more of: the historical records 126 and the user records 128 that may store information indicating historical calls from one or more of the user 108 and other callers; and information associated with the user 108.

At a block 310, the controller 218, and/or the PSAP device 102, controls receives (e.g., via the communication interface 202) the VR device 106 to provide the call 110 using the particular virtual reality environment and the particular avatar.

Indeed, at the block 310, the call taker 114 may be interacting with the user 108 via using the particular virtual reality environment and the particular avatar. Furthermore, the particular avatar that is determined and provided on the call 110 may or may not correspond to an appearance and/or demographic of the call taker 114. For example, while the call taker 114 may talk to the user 108 on the call 110 via the particular avatar, the particular avatar may not look and/or sound like the call taker 114. For example, when the call taker 114 is a man, and the particular avatar represents a women, the call taker 114 may speak into a microphone at the terminal 112, and the call-taking engine 104 may alter the voice of the call taker 114 to sound like a women, or vice versa. Alternatively, when the call taker 114 is a man, and the particular avatar also represents a man but of a different demographic as the call taker 114, the call taker 114 may speak into a microphone at the terminal 112, and the call-taking engine 104 may alter the voice of the call taker 114 to sound like the demographic being represented by the particular avatar, and the like.

Furthermore, it is understood that the user 108 may be represented in the particular virtual reality environment via an avatar that may be preselected by the user 108, though the call-taking engine 104 may nonetheless provide unaltered images of the user 108 to the call taker 114 at the terminal 112 so that the call taker 114 may view the unaltered images of the user 108.

The method 300 may include other features.

For example, as depicted, after the block 310, the method 300 may be repeated from the block 304 until the call 110 ends as, for example, as the call 110 continues, the controller 218, and/or the PSAP device 102 may change a type 142 of the call 110, and/or the sensor data 138 may change, which may cause the controller 218, and/or the PSAP device 102 to change one or more of the particular virtual reality environment and the particular avatar.

In a particular example, the method 300 may further comprise, the controller 218, and/or the PSAP device 102: continuing to receive the sensor data 138 during the call 110; and one or more of: changing the particular virtual reality environment to another particular virtual reality environment based on the sensor data 138 received during the call 110; and changing the particular avatar to another particular avatar based on the sensor data 138 received during the call 110.

Alternatively, or in addition, the method 300 may further comprise, the controller 218, and/or the PSAP device 102: changing a virtual reality environment of the call 110 according to stages of the call 110, wherein at least one of the stages includes controlling the VR device 106 to provide the particular virtual reality environment.

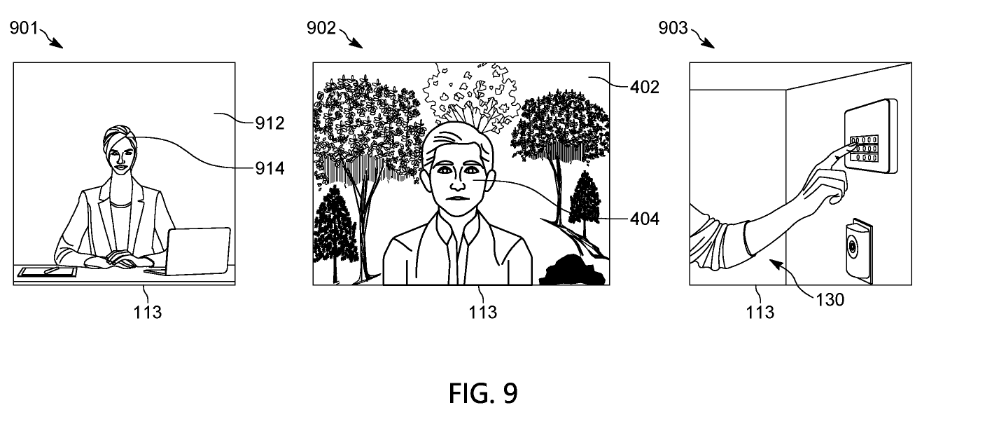

For example, such stages may include, but are not limited, an automated call answering stage, a call taker interaction stage, and a final stage, and are described in more detail below with respect to FIG. 9.

In the automated call answering stage, the call 110 may initially answered by the call-taking engine 104, which may ask particular questions of the user 108 to prompt the user 108 to indicate a type 142 of the call 110. At the automated call answering stage, a virtual reality environment and avatar may or not be provided on the call 110. For example, the call-taking engine 104 may ask particular questions of the user 108 only via audio, or the call-taking engine 104 may ask particular questions of the user 108 by providing the questions in a virtual reality environment and using an automated avatar (e.g., an avatar that is not at least partially controlled by the call taker 114). The virtual reality environment and/or the automated avatar may appear the same as, or appear different from, the particular virtual reality environment and/or the particular avatar determined at the block 308.

In the call taker interaction stage, control of the call 110 may be transferred to the terminal 112, such that the call taker 114 interacts with the user 108 on the call 110 in the particular virtual reality environment determined at the block 308 as provided by the call-taking engine 104, with the call taker 114 represented on the call 110 as the particular avatar determined at the block 308 as provided by the call-taking engine 104.

In the final stage, control of the call 110 may be transferred back to the call-taking engine 104, which interacts with the user 108 on the call 110 to ask any final questions, and/or provide VR-based demonstration media 130 that may assist the user 108. In this stage, the call-taking engine 104 may ask the final questions only via audio, or the call-taking engine 104 may ask the final questions of the user 108 by providing the questions in a virtual reality environment and using an automated avatar. The virtual reality environment and/or the automated avatar may be the same as, or different from, the particular virtual reality environment and/or the particular avatar determined at the block 308.

Alternatively, or in addition, the method 300 may further comprise, the controller 218, and/or the PSAP device 102: initially controlling the particular avatar via input received at a communication device associated with the call taker 114 (e.g., which may be represented by the headset 122); and later controlling the particular avatar automatically after the communication device of the call taker 114 has left the call 110. Such an example may occur when the call 110 moves from the call taker interaction stage to the final stage.

Alternatively, or in addition, the call 110 may be initially received outside a virtual reality environment, and the method 300 may further comprise, the controller 218, and/or the PSAP device 102: based on one or more of the type 142 of the call 110 and the sensor data 138, moving the call 110 to the particular virtual reality environment.

For example, when the call 110 is initially made using a call-placing application at a mobile phone, the call-taking engine 104 may answer the call 110 and ask the user 108 on the call whether or not they’d like to move the call 110 to a virtual reality environment. When the answer is “Yes”, and the like, the user 108 may operate the mobile phone and/or the VR device 106 to transfer the call 110 to the VR device 106 in any suitable manner, and/or call-taking engine 104 may provide a command to the mobile phone to transfer the call 110 to the VR device 106. For example, the call 110 may then be transferred to a VR application at the mobile phone, such that the VR application launches automatically (or is launched manually), and takes over the call 110. Alternatively, the call 110 may be transferred to the headset 106a, which may occur via the mobile phone communicating with the headset 106a and/or acting as an interface between the headset 106a and the PSAP device 102.

Alternatively, or in addition, the method 300 may further comprise, the controller 218, and/or the PSAP device 102: patching a respective VR device 132 associated with a first responder 134 into the call 110; and based on the type 142 of the call 110 and the sensor data 138, determining a particular respective avatar for the first responder.

For example, the call taker 114 may interact with the user 108 on the call 110, and determine that the first responder 134 should at least listen in on the call 110. In these examples, the call taker 114 may operate the terminal 112 to select a network address of the VR device 132 associated with the first responder 134 to call the VR device 132, to patch the VR device 132 into the call 110. In these example, the call-taking engine 104 may determine a particular respective avatar for the first responder 134 that may or may not correspond to the demographic of the first responder 134, and which may further be determined to attempt to reduce stress of the user 108 as determined from the sensor data 138. The particular respective avatar for the first responder 134 may appear in the particular virtual reality environment.

Alternatively, or in addition, the method 300 may further comprise, the controller 218, and/or the PSAP device 102: patching a respective VR device 132 associated with a first responder 134 into the call 110; and based on the type 142 of the call 110 and the sensor data 138, patching the respective VR device 106 into the call 110 in a visible mode or an invisible mode.

In these examples, when the VR device 132 associated with a first responder 134 is patched into the call 110, in a visible mode, a particular respective avatar for the first responder 134 may appear in the particular virtual reality environment.

However, in an invisible mode, the VR device 132 associated with a first responder 134 may be patched into the call 110 without providing any particular respective avatar for the first responder 134. Put another way, in an invisible mode, the first responder 134 may use the VR device 132 to listen in on the call 110, and/or observe any images of the user 108 on the call 110, but the VR device 132 may otherwise be muted.

In some examples, the call-taking engine 104 may automatically patch the VR device 132 associated with a first responder 134 into the call 110 in a visible mode or an invisible mode, based, or example, on whether previous calls of a similar or same type 142 caused stress of previous users to increase or decrease when a first responder was on a call in a visible mode or an invisible mode. For example, when previous calls of a similar or same type 142 caused stress of previous users to increase when a first responder was on a call in a visible mode, the VR device 132 associated with a first responder 134 may be patched into the call 110 in an invisible mode, and vice versa. However, in some examples, the call-taking engine 104 may not automatically patch the VR device 132 associated with a first responder 134 into the call 110 in a visible mode or an invisible mode, but may provide a recommendation to the call taker 114 to patch the VR device 132 associated with a first responder 134 into the call 110 in a visible mode or an invisible mode. The call taker 114 may accept or decline the recommendation, and/or manually select whether to patch the VR device 132 associated with a first responder 134 into the call 110 in a visible mode or an invisible mode. Such a recommendation may be provided at the display screen 116 of the terminal 112 and/or within the particular virtual reality environment, and the like, as one or more electronic buttons that may be operated accordingly.

Alternatively, or in addition, the method 300 may further comprise, the controller 218, and/or the PSAP device 102: providing, within the particular virtual reality environment, one or more VR-based demonstrations to address an incident associated with the call 110. For example, the call taker 114 may operate the terminal 112 to select one or more sets of VR-based demonstration media 130 that may be played in the call 110, for example in the particular virtual reality environment, to provide the user 108 with one or more procedures that may be associated with different incidents and/or different mental health states (e.g., such as depression).

Attention is next directed to FIGS. 4, 5, 6, 7, 8, and 9 that depict aspects of the method 300.

Attention is first directed to FIG. 4, that is substantially similar to FIG. 1 with like components having like numbers. However, for simplicity, the sensors 136 and the call-type detector engine 140 are omitted, but the sensor data 138 and the call type 142 continue to be shown to emphasize that the sensor data 138 and the call type 142 may continue to be determined over the call 110.

FIG. 4, like FIG. 1, depicts the call 110 having been received (e.g., at the block 302 of the method 300) at the PSAP device 102, and in particular at the call-taking engine 104. However, as depicted, the call 110 has been provided to the terminal 112, though the call-taking engine 104 continues to assist with the call 110 as described herein; hence the call 110 is depicted as being between the VR device 106 and the terminal 112, via the call-taking engine 104.

As further depicted in FIG. 4, the VR device 106 may be operated by the user 108 to provide audio and/or image data 400 on the call 110, that may be provided to the call-taking engine 104 and passed to the terminal 112. The audio and/or image data 400 may include the aforementioned sensor data 138 received in association with the location of the user 108, and/or from the VR device 106, and the like. Indeed, the audio and/or image data 400 may further be analyzed by the sensors 136 as described herein.

FIG. 4 further depicts the PSAP device 102 determining (e.g., at the block 304 of the method 300), the call type 142 (e.g., using the call-type detector engine 140 analyzing audio of the audio and/or image data 400, and the like), which is provided to the call-taking engine 104.

FIG. 4 further depicts the PSAP device 102 receiving (e.g., at the block 306 of the method 300), the sensor data 138 (e.g., via the sensor 136 analyzing audio and/or images of the audio and/or image data 400, and the like), which is provided to the call-taking engine 104.

FIG. 4 further depicts the PSAP device 102 determining a particular virtual reality environment 402 and a particular avatar 404 for the call taker 114 of the call 110, for example based on the sensor data 138 and the call type 142 provided to the call-taking engine 104.

FIG. 4 further depicts the PSAP device 102 controlling the VR device 106 to provide the call 110 using the particular virtual reality environment 402 and the particular avatar 404, for example by providing, to the VR device 106 the particular virtual reality environment 402 and the particular avatar 404. Indeed, the particular virtual reality environment 402 and the particular avatar 404 provided to the VR device 106 may represent instructions and/or programming instruction for controlling a display screen 113 of the VR device 106 to render the particular virtual reality environment 402 and the particular avatar 404 and/or for controlling a speaker of the VR device 106 to provide audio that may appear to be spoken by the particular avatar 404 on the call 110.

For example, the call taker 114 may provide audio 406 on the call 110 that is converted by the call-taking engine 104 into audio provided by the particular avatar 404 at the VR device 106. While not depicted, the call taker 114 may provide other information on the call 110, such as text data that may be display screen 113 of the VR device 106.

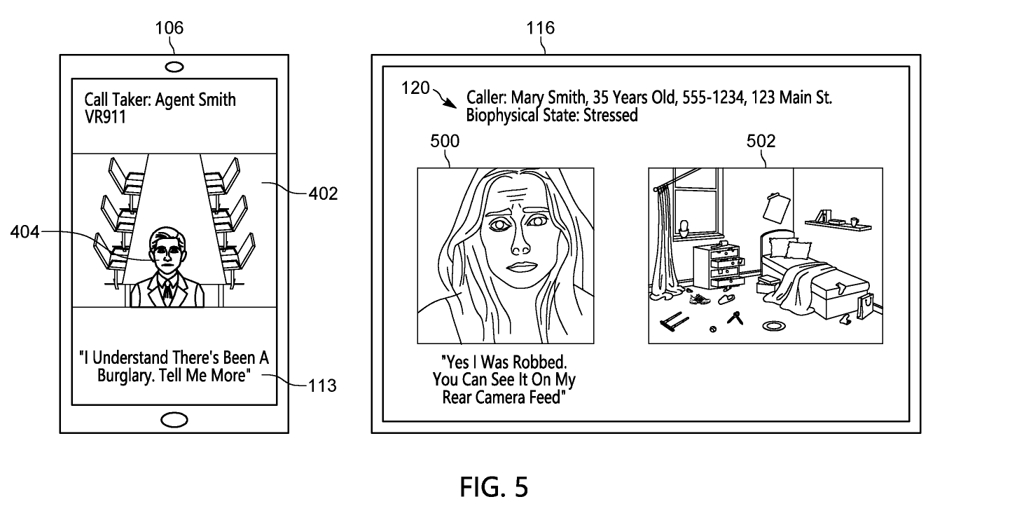

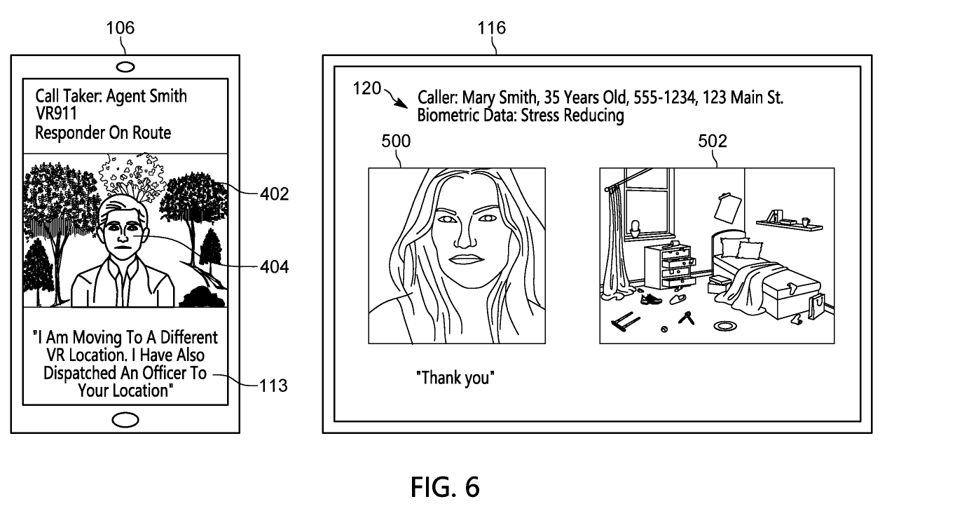

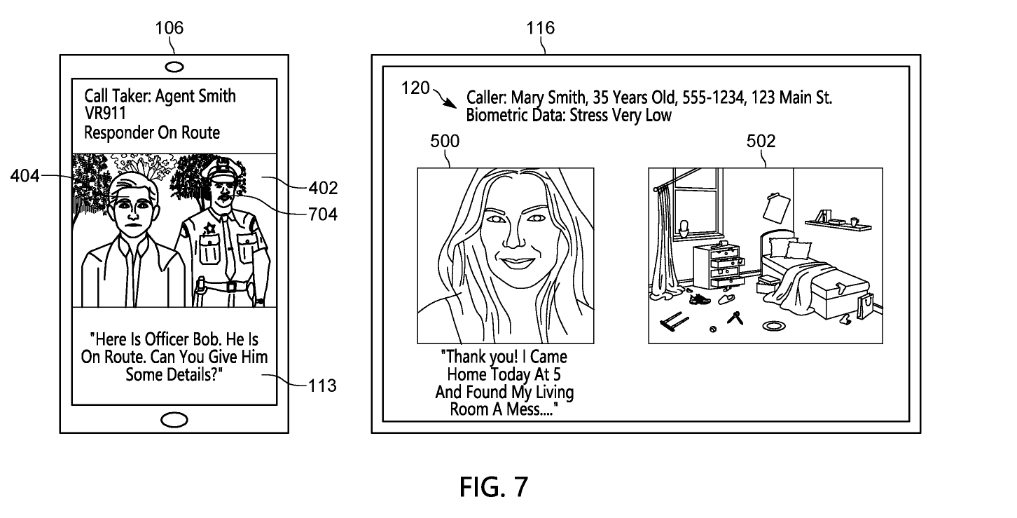

Attention is next directed to FIG. 5, FIGS. 6, and 7, which depicts the VR device 106 and the display screen 116 of the terminal 112 over the length of the call 110. Hence it is understood that FIG. 5, FIGS. 6, and 7 may represent a sequence, over time of the call 110, and how the particular virtual reality environment 402 and the particular avatar 404 may change over time.

For example, with attention first directed to FIG. 5, the particular avatar 404 and the particular virtual reality environment 402 provided at the display screen 113 of the VR device 106 may respectively comprise a middle aged man, wearing a suit, in a boardroom.

As depicted, an identifier of the call taker 114, as depicted “Agent Smith” may also be provided at the display screen 113, as well as an indication “VR911” of the call 110 being provided in a virtual reality environment.

As depicted, at the display screen 116 of the terminal 112, for example within the interface 120, video 500 (e.g., and/or images) of the user 108 may be provided, as well as an image 502 of a location of the user 108. The video 500 and the image 502 may be received in the audio and/or image data 400. As depicted, a name, age, phone number and address of the user 108 is also depicted (e.g., “Caller: Mary Smith, 35 years old, 555-1234, 123 Main St.”), which may be from an associated user record 128 and/or may have been received from the user 108 in a call-answering stage.

As also depicted at the display screen 116, an indication of a biophysical state of the user is also provided, and in particular “Biophysical State: Stressed”, which may be determined from the sensor data 138. While the indication of a biophysical state summarized the biophysical state as “Stressed” for simplicity, in other examples, more details from the sensor data 138 may be provided, such as a heart rate. Indeed, the summary of the biophysical state as “Stressed” may be determined by the call-taking engine 104. In some examples, the biophysical state of the user as “Stressed” may be determined, at least in part, by arrangements of pixels in the video 500 showing a mouth of the user 108 being pursed or turned downward, furrows in a forehead of the user 108, and the like.

As also depicted in FIG. 5, the call taker 114 may say, via the particular avatar 404 “I understand there’s been a burglary. Tell me more”, and the user 108 may reply “Yes I was robbed. You can see it on my rear camera feed”. While the conversation is depicted as being textual for simplicity, the conversation may be provided via the audio of the audio and/or image data 400, and the audio 406 (converted to audio for the particular avatar 404).

Presuming the call type 142 is a burglary type call, and the user 108 being stressed, the call-taking engine 104 may initially determine that the particular avatar 404 and the particular virtual reality environment 402 of a middle aged man in a boardroom may cause the sensor data 138 to change to indicate reduced stress of the user 108. However, over the call 110, the PSAP device 102 (e.g., via the call-taking engine 104) may determine that the sensor data 138 that continues to be received does not indicate that stress is being reduced at the user 108.

As such, and with attention next directed to FIG. 6, the PSAP device 102 (e.g., via the call-taking engine 104) may change the particular avatar 404 and the particular virtual reality environment 402 to the same man, but wearing casual clothes and located in a forest. For example, the PSAP device 102 (e.g., via the call-taking engine 104) may determine that the man wearing casual clothes and located in a forest may reduce the stress of the user 108.

As depicted the particular avatar 404 says “I am moving to a different VR location. I have also dispatched an officer to your location”, and the biometric data indication of the user 108 at the display screen 116 now shows “Stress Reducing”, and the user 108 replied “Thank You”. Indeed, comparing the video 500 in FIGS. 5 and 6, the user 108 appears less stressed in FIG. 6 than in FIG. 5, and the indication of “Stress Reducing” is understood to be determined from the sensor data 138 that is continuing to be received. In some examples, the biophysical state of the user as “Stress Reducing” (e.g., relative to as depicted in FIG. 5) may be determined, at least in part, by arrangements of pixels in the video 500 showing a mouth of the user 108 being neutral, the furrows in the forehead of the user 108 being reduced (e.g., relative to as depicted in FIG. 5), and the like.

FIG. 6 further shows that the display screen 113 of the VR device 106 may be updated to show that “Responder On Route”, indicating that the call taker 114 has dispatched a first responder, such as the first responder 134 to the location of the user 108 (e.g., by operating the terminal 112 accordingly).

With attention next directed to FIG. 7, the call taker 114 may decide to patch the VR device 132 of the first responder 134 into the call 110, and the call-taking engine 104 may determine a respective avatar 704 for the first responder 134, and insert the respective avatar 704 into the particular virtual reality environment 402.

As depicted the particular avatar 404 says “Here is Officer Bob. He is on route. Can you give him some details?”, and the biometric data indication of the user 108 at the display screen 116 now shows “Stress Very Low”, and the user 108 replies “Thank you! I came home today at 5 and found my living room a mess...”. Indeed, comparing the video 500 in FIGS. 6 and 7, the user 108 appears less stressed in FIG. 7 than in FIG. 6, and the indication of “Stress Very Low” is understood to be determined from the sensor data 138 that is continuing to be received. In some examples, the biophysical state of the user as “Very Low” (e.g., relative to as depicted in FIG. 6) may be determined, at least in part, by arrangements of pixels in the video 500 showing a mouth of the user 108 smiling, and the like.

While not depicted, the first responder 134 may operate the VR device 132 to also talk on the call 110. Furthermore, the avatar 704 of the first responder 134 may or may not correspond to an actual appearance of the first responder 134, though in some examples, the avatar 704 of the first responder 134 should be close to the actual appearance of the first responder 134 so as to not confuse the user 108 when the first responder 134 arrives at their location.

Regardless, the changing of the particular virtual reality environment 402 and the particular avatar 404, and optionally the addition of the avatar 704 of the first responder 134, may cause the sensor data 138 to indicate decreased stress of the user 108, which may shorten a length of the call 110, which may free processing resources and/or bandwidth at the PSAP device 102 to answer more calls.

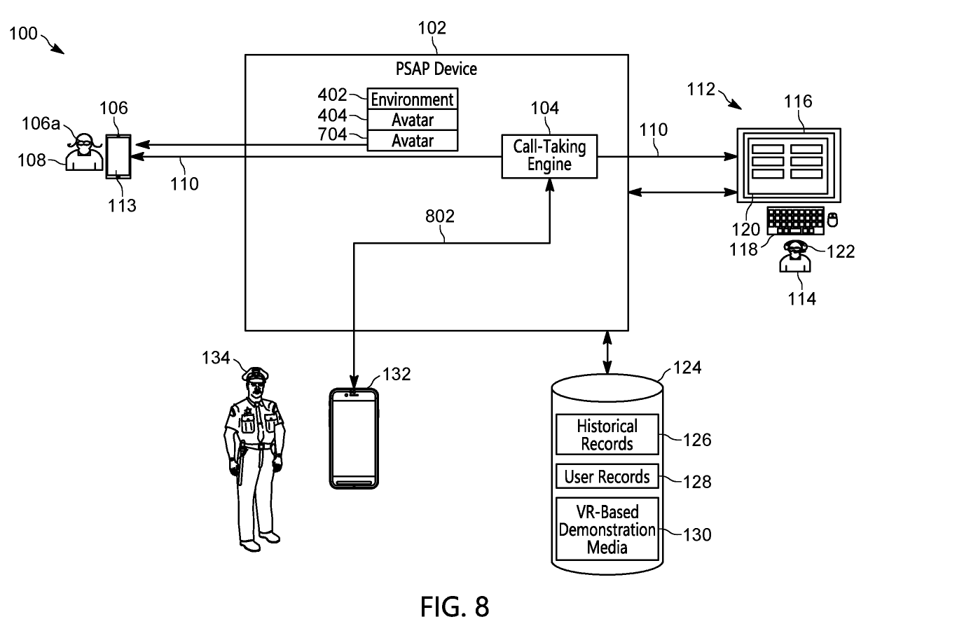

To illustrate the VR device 132 being patched into the call 110, attention is next directed to FIG. 8, which depicts a communication link 802 between the VR device 132 and the call-taking engine 104, which inserts the avatar 704 into the particular virtual reality environment 402 by providing the avatar 704 to the VR device 106 with the particular virtual reality environment 402 and the particular avatar 404.

Attention is next directed to FIG. 9, which depicts various stages that may occur on a call 110, such as an automated call answering stage 901, a call taker interaction stage 902, and a final stage 903, which are all understood to be provided on the call 110, and each stage 901, 902, 903 may be provided at the display screen 113 of the VR device 106.

For example, at the automated call answering stage 901, and the call-taking engine 104 initially answers the call 110, a VR environment 912 of an office and a desk may be provided on the call 110, with an automated VR avatar of a woman 914 who may be controlled by the call-taking engine 104 to ask questions of the user 108 (e.g., name, age, phone number, address, incident they are calling about), and the like.

When the call 110 is transferred to the terminal 112, the call 110 may change to the call taker interaction stage 902, and as depicted, the particular virtual reality environment 402 and the particular avatar 404 of the call taker 114 is similar to as depicted in FIG. 6.

At a later state of the call 110, for example when the call taker 114 has completed interactions with the user 108, control of the call 110 may be transferred back to the call-taking engine 104 at the final stage 903, and one or more VR-based demonstrations to address the incident associated with the call 110 may be provided on the call 110, for example by playing one or more sets of the VR-based demonstration media 130. For example, as depicted, a set of VR-based demonstration media 130 is being played at the display screen 113, on the call 110, to demonstrate how to check if a home security system is functioning.

While not depicted, at the final stage 903, the PSAP device 102 may continue to provide the later controlling the particular avatar 404 automatically after the call taker 114 has left the call 110.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot measure stress using electronically received or determined stress data, cannot operate machine learning algorithms, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the "C" programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, by a public safety answering point (PSAP) device, a call placed by a user of a virtual reality (VR) device;
determining, by the PSAP device, a type of the call;
receiving, by the PSAP device, sensor data indicative of a biophysical state of the user;
based on the type of the call and the sensor data, determining, by the PSAP device: a particular virtual reality environment and a particular avatar for a call taker of the call; and
controlling, by the PSAP device, the VR device to provide the call using the particular virtual reality environment and the particular avatar.

2. The method of claim 1, further comprising:
continuing to receive the sensor data during the call; and one or more of:
changing the particular virtual reality environment to another particular virtual reality environment based on the sensor data received during the call; and
changing the particular avatar to another particular avatar based on the sensor data received during the call.

3. The method of claim 1, further comprising:
changing a virtual reality environment of the call according to stages of the call, wherein at least one of the stages includes controlling the VR device to provide the particular virtual reality environment.

4. The method of claim 1, wherein the call is initially received outside a virtual reality environment, and the method further comprises:
based on one or more of the type of the call and the sensor data, moving the call to the particular virtual reality environment.

5. The method of claim 1, further comprising:
patching a respective VR device associated with a first responder into the call; and
based on the type of the call and the sensor data, selecting a particular respective avatar for the first responder.

6. The method of claim 1, further comprising:
patching a respective VR device associated with a first responder into the call; and
based on the type of the call and the sensor data, patching the respective VR device into the call in a visible mode or an invisible mode.

7. The method of claim 1, wherein the sensor data is received from sensors of one or more of:
the VR device;
a communication device initially used to make the call;
a location of the user;
a spectrum analyzer analyzing voice data of the user; and
a video analyzer analyzing image data of the user.

8. The method of claim 1, wherein one or more of particular virtual reality environment and the particular avatar are selected further based on one or more of:
historical calls from one or more of the user and other callers; and
information associated with the user available to the PSAP device.

9. The method of claim 1, further comprising:
providing, within the particular virtual reality environment, one or more VR-based demonstrations to address an incident associated with the call.

10. The method of claim 1, further comprising:
initially controlling the particular avatar via input received at a communication device associated with the call taker; and
later controlling the particular avatar automatically after the communication device of the call taker has left the call.

11. A computing device comprising:
a controller; and
a computer-readable storage medium having stored thereon program instructions that, when executed by the controller, causes the controller to perform a set of operations comprising:
receiving a call placed by a user of a virtual reality (VR) device;
determining a type of the call;
receiving sensor data indicative of a biophysical state of the user;
based on the type of the call and the sensor data, determining: a particular virtual reality environment and a particular avatar for a call taker of the call; and
controlling the VR device to provide the call using the particular virtual reality environment and the particular avatar.

12. The computing device of claim 11, wherein the set of operations further comprise:
continuing to receive the sensor data during the call; and one or more of:
changing the particular virtual reality environment to another particular virtual reality environment based on the sensor data received during the call; and
changing the particular avatar to another particular avatar based on the sensor data received during the call.

13. The computing device of claim 11, wherein the set of operations further comprise:
changing a virtual reality environment of the call according to stages of the call, wherein at least one of the stages includes controlling the VR device to provide the particular virtual reality environment.

14. The computing device of claim 11, wherein the call is initially received outside a virtual reality environment, and the set of operations further comprise:
based on one or more of the type of the call and the sensor data, moving the call to the particular virtual reality environment.

15. The computing device of claim 11, wherein the set of operations further comprise:
patching a respective VR device associated with a first responder into the call; and
based on the type of the call and the sensor data, selecting a particular respective avatar for the first responder.

16. The computing device of claim 11, wherein the set of operations further comprise:
patching a respective VR device associated with a first responder into the call; and
based on the type of the call and the sensor data, patching the respective VR device into the call in a visible mode or an invisible mode.

17. The computing device of claim 11, wherein the sensor data is received from sensors of one or more of:
the VR device;
a communication device initially used to make the call;
a location of the user;
a spectrum analyzer analyzing voice data of the user; and
a video analyzer analyzing image data of the user.

18. The computing device of claim 11, wherein one or more of particular virtual reality environment and the particular avatar are selected further based on one or more of:
historical calls from one or more of the user and other callers; and
information associated with the user available to the PSAP device.

19. The computing device of claim 11, wherein the set of operations further comprise:
providing, within the particular virtual reality environment, one or more VR-based demonstrations to address an incident associated with the call.

20. The computing device of claim 11, wherein the set of operations further comprise:
initially controlling the particular avatar via input received at a communication device associated with the call taker; and
later controlling the particular avatar automatically after the communication device of the call taker has left the call.
